(19) United States
(12) Patent Application Publication
(10) Pub. No.: US 2014/0368852 A1
(43) Pub. Date: Dec. 18, 2014

(54) INFORMATION PROCESSING APPARATUS, PRINT PROCESSING METHOD AND PRINT PROCESSING PROGRAM

(71) Applicants: Akira TERUYA, Kanagawa (JP); Kenichi FUJIOKA, Kanagawa (JP)

(72) Inventors: Akira TERUYA, Kanagawa (JP); Kenichi FUJIOKA, Kanagawa (JP)

(21) Appl. No.: 14/290,248

(22) Filed: May 29, 2014

(30) Foreign Application Priority Data
Jun. 14, 2013 (JP) 2013-125499

(51) Int. Cl. G06K 15/02

(52) U.S. Cl. CPC G06K 15/1805
USPC 358/1.13

(57) ABSTRACT

An information processing apparatus having print architecture based on Common UNIX (registered trademark) Printing System includes a print setting information generator to generate print setting information; a print job generator to generate a print job based on the print setting information; an identification information issuing unit to generate identification information; a print setting detector to determine whether a given print setting having data size exceeding maximum data size that the print job generator can receive exists in the print setting input; a data file generator to generate a data file including the identification information and given print setting information; a file storing unit to store the given print setting information in the data file in a memory; and an identification information transmitter to transmit the identification information to the print job generator. The print job generator obtains the given print setting information in the memory using the transmitted identification information.

This application claims priority pursuant to 35 U.S.C. §119 to Japanese Patent Application No. 2013-125499, filed on Jun. 14, 2013 in the Japan Patent Office, the disclosures of which are incorporated by reference herein in their entirety.

### BACKGROUND

1. Technical Field

The present invention relates to an information processing apparatus, a print processing method, and a print processing program.

2. Background Art

Typically, an operating system (OS) installed in a host computer includes a print system program used for supporting a printing operation under an environment that a printer is connected to the host computer that issues a print request.

As one of print system programs, Common UNIX (registered trademark) Printing System (CUPS) embedded in UNIX (operating system) OS is known.

FIG. 7 shows a print architecture based on the CUPS. A personal computer (PC) 201 is used as an information processing apparatus operable by UNIX (registered trademark) OS. The PC 201 includes, for example, an application 202, CUPS 203, and a printer driver 204 as software modules.

The CUPS 203 includes, for example, a scheduler 205, an information communication processing unit 206 such as CUPS Command File Filter, a print job generator 207 such as CUPS Vendor Filter, a print job transmitter 208 such as Backend Filter, and a postscript printer description (PPD) file 210.

The printer driver 204 includes, for example, four modules such as a print setting unit 209, the PPD file 210, the information communication processing unit 206, and the print job generator 207. The print setting unit 209 such as Print Dialog Extension (PDE) manages input of print settings via the application 202.

The print setting unit 209 is embedded in a user interface (UI) module of OS to operate. The PPD file 210, the information communication processing unit 206, and the print job generator 207 are embedded in the CUPS 203, respectively, to operate.

FIG. 8 shows a flow of print setting information to be communicated in the print architecture of FIG. 7. At first, the print setting unit 209 receives print setting from a user (process 1). More specifically, the print setting unit 209 generates a print setting screen, which functions as a graphical user interface (GUI), by referring the PPD file 210, and receives the print setting, which is input by a user through the screen.

Upon completing the print setting input by the user, the print setting unit 209 generates print setting information, and transfers the print setting information to the application 202. The application 202 receives and stores the print setting information (process 2).

Upon detecting a print-start request by the user, the application 202 transmits a print instruction and the print setting information stored at the process 2 to the scheduler 205 (process 3). The print-start request can be detected when a print-start button on the print setting screen is pressed.

The scheduler 205 transfers the received print setting information to the print job generator 207 (process 4). The print job generator 207 generates a print job based on the received print setting information, and transfers the generated print job to the print job transmitter 208 (process 5). The print job transmitter 208 transfers the received print job to a printer.

In this processing, the print job generator 207 receives the print setting information in a command line input format of UNIX (registered trademark) as illustrated in FIG. 9. The print job generator 207 can receive print setting information shown in Table 1 using argv[1] to argv[6]. However, UNIX (registered trademark) command line input format has a limitation for the number of characters that can be received such as 256 KB at maximum. Therefore, the maximum data size of print setting information that the print job generator 207 can obtain using argv[1] to argv[6] is limited about 256 KB.

TABLE 1

| | |
|---|---|
| argv[1] | Job ID |
| argv[2] | Print user name |
| argv[3] | Job name/title |
| argv[4] | Print number |
| argv[5] | Print setting information other than argv[1] argv[4] |
| argv[6] | File name of print target data |

In commercial printing business, print outputs themselves may become commercial products. Therefore, printers used for commercial printing are demanded to output print-outputs having enhanced added values such as print outputs having, for each page, different print settings or having different types of print media, which is different from office printing that outputs simple print-output. The above mentioned page-by-page print settings can be devised using a function known as special page (or exceptional page) function.

The special page function can set various settings for special page such as cover/intermission sheet placed between two sheets, insertion page/tab print, exceptional page, or the like, and each of which can be set independently. Table 2 shows data size of print setting information used for special page function.

TABLE 2

| | | | Maximum data size |
|---|---|---|---|
| Type of special | | | to be used for one |
| page | Print setting for use | Setting | page |
| cover/ | Sheet size, sheet | only one | about 1 KB |
| intermission sheet | type | page | |
| Insertion page/ | Sheet size, sheet | each page | about 2 KB |
| tab print | type, tab print | | |
| | character line, font | | |
| exceptional page | Sheet size, sheet | each page | about 1.5 KB |
| | type, | | |
| | post-processing | | |
| | setting, face setting | | |

In these special page functions, maximum data size used for print settings per one page is about 2 KB for insertion page/tab print. Therefore, the number of special pages that the print job generator 207 can receive becomes about 128 at maximum based on the following formula (1).

(Print setting data size receivable with argv[1] to argv [5])±(Maximum data size of one special page)=256 KB±2 KB=128 (1)

Therefore, the number of special pages that can be registered with a printer driver (print processing program) of commercially available CUPS becomes, for example, 200 at maximum as shown in Table 3.

TABLE 3

| | | Maximum |
|---|---|---|
| | | registration |
| Company | | number |
| name | Printer driver name | of special pages |
| Xerox | Color 1000 press (FreeFlow server model) | 200 |
| Konica | Bizhub Pro C8000 (IS601 model) | 144 |
| Minolta | | |
| EFI | Ricoh C751-C651 EX (Fiery model) | 100 |

As above described, due to the limitation of command line input format, printer drivers of commercially available CUPS cannot set the number of special pages greater than the number of special pages that the print job generator can receive, which is inconvenient for users.

### SUMMARY

In one aspect of the present invention, an information processing apparatus having a print architecture based on Common UNIX (registered trademark) Printing System (CUPS) is devised. The information processing apparatus includes a print setting information generator to generate print setting information indicating print setting based on a print setting input; a print job generator to generate a print job based on the print setting information; an identification information issuing unit to generate identification information; a print setting detector to determine whether a given print setting having a data size exceeding the maximum data size that the print job generator can receive exists in the print setting input; a data file generator to generate a data file including the identification information generated by the identification information issuing unit and given print setting information indicating the given print setting when the given print setting exists; a file storing unit to store the given print setting information in the data file in a memory by correlating the given print setting information to the identification information in the data file; and an identification information transmitter to transmit the identification information to the print job generator, The print job generator obtains the given print setting information in the memory using the identification information transmitted from the identification information transmitter.

In another aspect of the present invention, a print processing method conductable by an information processing apparatus having a print architecture based on Common UNIX (registered trademark) Printing System (CUPS) is devised. The method includes the steps of generating print setting information indicating print setting based on a print setting input using a print setting information generator; generating identification information using the identification information issuing unit; determining whether a given print setting having data size exceeding maximum data size that the print job generator can receive exists in the print setting input using a print setting detector; generating a data file including the identification information and given print setting information indicating the given print setting using a data file generator when the given print setting exists; storing the given print setting information in the data file in a memory by correlating the given print setting information to identification information in the data file using a file storing unit; transmitting the identification information to the print job generator using an identification information transmitter; and obtaining the given print setting information in the memory using the print job generator based on the transmitted identification information from the identification information transmitter.

In another aspect of the present invention, a non-transitory computer-readable storing medium storing a program that, when executed by a computer, causes the computer to execute a print processing method conductable by an information processing apparatus having a print architecture based on Common UNIX (registered trademark) Printing System (CUPS) is devised. The method includes the steps of generating print setting information indicating print setting based on a print setting input using a print setting information generator; generating identification information using the identification information issuing unit; determining whether a given print setting having data size exceeding maximum data size that the print job generator can receive exists in the print setting input using a print setting detector; generating a data file including the identification information and given print setting information indicating the given print setting using a data file generator when the given print setting exists; storing the given print setting information in the data file in a memory by correlating the given print setting information to identification information in the data file using a file storing unit; transmitting the identification information to the print job generator using an identification information transmitter; and obtaining the given print setting information in the memory using the print job generator based on the transmitted identification information from the identification information transmitter.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1A is a functional block diagram of an information processing apparatus according to an example embodiment;

FIG. 1B is an example hardware configuration of the information processing apparatus of FIG. 1A;

FIG. 2 is a flow chart showing the steps of print setting process of a printer driver of FIG. 1A;

FIGS. 3A and 3B are a flow chart showing the steps of detail process of print setting process of a printer driver of FIG. 1A;

FIG. 4 is an example of an identifier generated by the process of FIG. 3;

FIG. 5 is an example of a data file format generated by the process of FIG. 3;

FIG. 6 is an example of a temporary file format generated by the process of FIG. 3;

FIG. 7 is an example of a print architecture based on CUPS;

FIG. 8 shows a reporting path of print setting information in the print architecture of FIG. 7; and

FIG. 9 is an example of an input format of print setting information at a print job generator of FIG. 7.

The accompanying drawings are intended to depict exemplary embodiments of the present invention and should not be interpreted to limit the scope thereof. The accompanying drawings are not to be considered as drawn to scale unless explicitly noted, and identical or similar reference numerals designate identical or similar components throughout the several views.

### DETAILED DESCRIPTION

A description is now given of exemplary embodiments of the present invention.

It should be noted that although such terms as first, second, etc. may be used herein to describe various elements, components, regions, layers and/or sections, it should be understood that such elements, components, regions, layers and/or sections are not limited thereby because such terms are relative, that is, used only to distinguish one element, component, region, layer or section from another region, layer or section. Thus, for example, a first element, component, region, layer or section discussed below could be termed a second element, component, region, layer or section without departing from the teachings of the present invention.

In addition, it should be noted that the terminology used herein is for the purpose of describing particular embodiments only and is not intended to be limiting of the present invention. Thus, for example, as used herein, the singular forms “a”, “an” and “the” are intended to include the plural forms as well, unless the context clearly indicates otherwise. Moreover, the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Furthermore, although in describing views shown in the drawings, specific terminology is employed for the sake of clarity, the present disclosure is not limited to the specific terminology so selected and it is to be understood that each specific element includes all technical equivalents that have a similar function, operate in a similar manner, and achieve a similar result. Referring now to the drawings, an apparatus or system according to an example embodiment is described hereinafter.

### Information Processing Apparatus Installed with Printer Driver

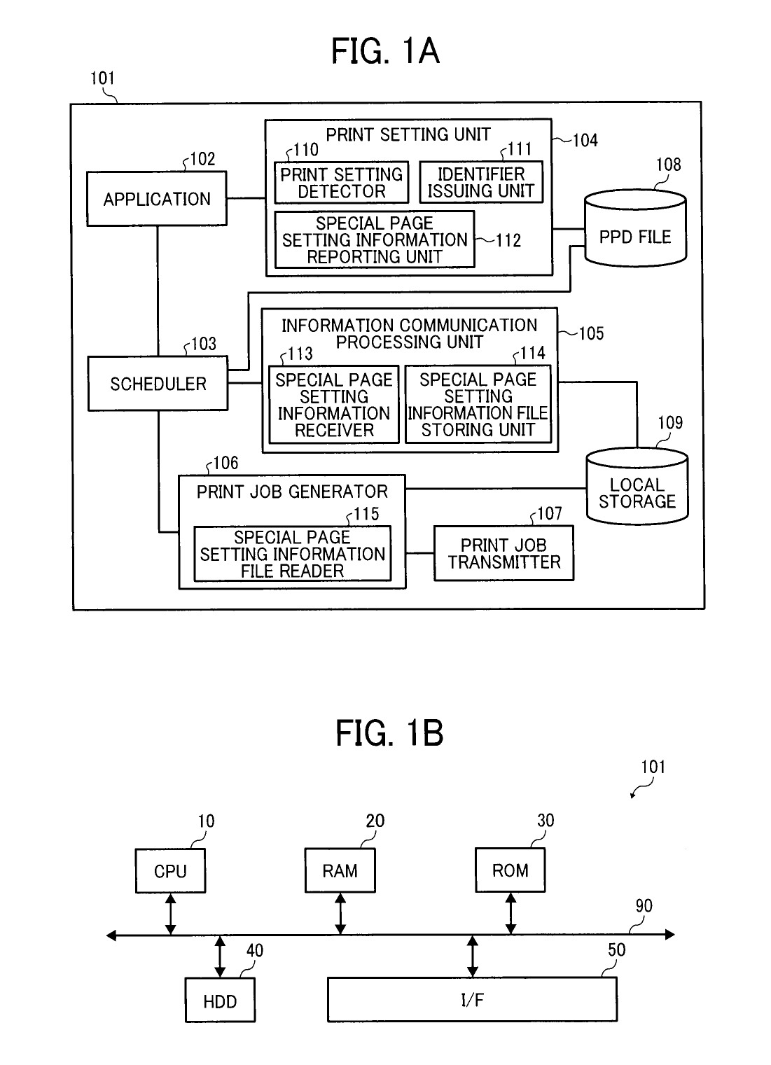

FIG. 1A is a functional block diagram of an information processing apparatus according to an example embodiment. As shown in FIG. 1B, a personal computer (PC) 101, which is an example of the information processing apparatus according to an example embodiment, includes a central processing unit (CPU) 10, a read only memory (ROM) 30, a random access memory (RAM) 20, a hard disk drive (HDD) 40 or the like, and can be operated using UNIX (registered trademark) OS. Each unit shown in the functional block diagram (FIG. 1A) can be devised by executing programs such as an operating system (OS), a printer driver, and an application installed to the PC 101.

The PC 101 can employ a print architecture based on Common UNIX (registered trademark) Printing System (CUPS), and includes, for example, an application 102, a scheduler 103, a print setting unit 104, an information communication processing unit 105, a print job generator 106, a print job transmitter 107, a postscript printer description (PPD) file 108, and a local storage 109.

In this configuration, the print setting unit 104, the information communication processing unit 105, the print job generator 106, and the PPD file 108 configure a printer driver used as a print processing program. Further, the scheduler 103, the information communication processing unit 105, the print job generator 106, and the print job transmitter 107 configure Common UNIX (registered trademark) Printing System (CUPS).

The print setting unit 104 is embedded in a user interface (UI) module of OS to operate. The PPD file 108, the information communication processing unit 105 and the print job generator 106 are embedded in the CUPS to operate.

The print setting unit 104 includes, for example, three modules such as a print setting detector 110, an identifier issuing unit 111, and a special page setting information reporting unit 112. The print setting detector 110 can function as a print setting detection unit that detects whether special page setting having data size exceeding the maximum data size that the print job generator 106 can receive exists. The identifier issuing unit 111 can function as an identification information issuing unit that generates an identifier, wherein the identifier is identification information that is uniquely identified. The special page setting information reporting unit 112 can function as a reporting unit that reports special page setting information to the information communication processing unit 105.

The information communication processing unit 105 includes, for example, a special page setting information receiver 113, and a special page setting information file storing unit 114. The special page setting information receiver 113 obtains the special page setting information reported from the print setting unit 104. The special page setting information file storing unit 114 can function as a file storing unit that stores a file of special page setting information in the local storage 109.

The print job generator 106, which can function as a print job generator, includes a special page setting information file reader 115. The special page setting information file reader 115 can function as a special page setting information obtaining unit that searches and reads a file of special page setting information stored in the local storage 109.

The print job transmitter 107 receives a print job generated by the print job generator 106, and transmits the print job to a printer.

### Print Setting Process of Printer Driver

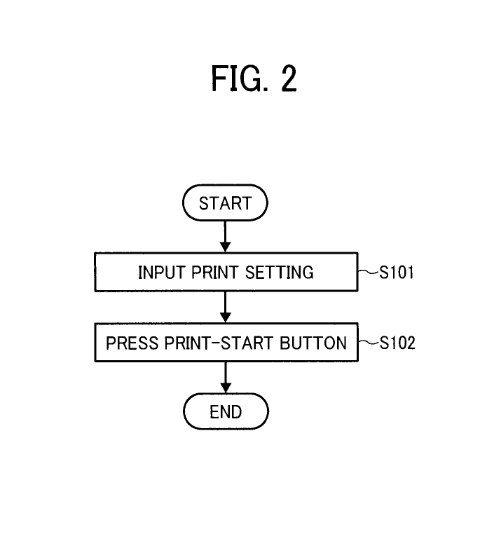

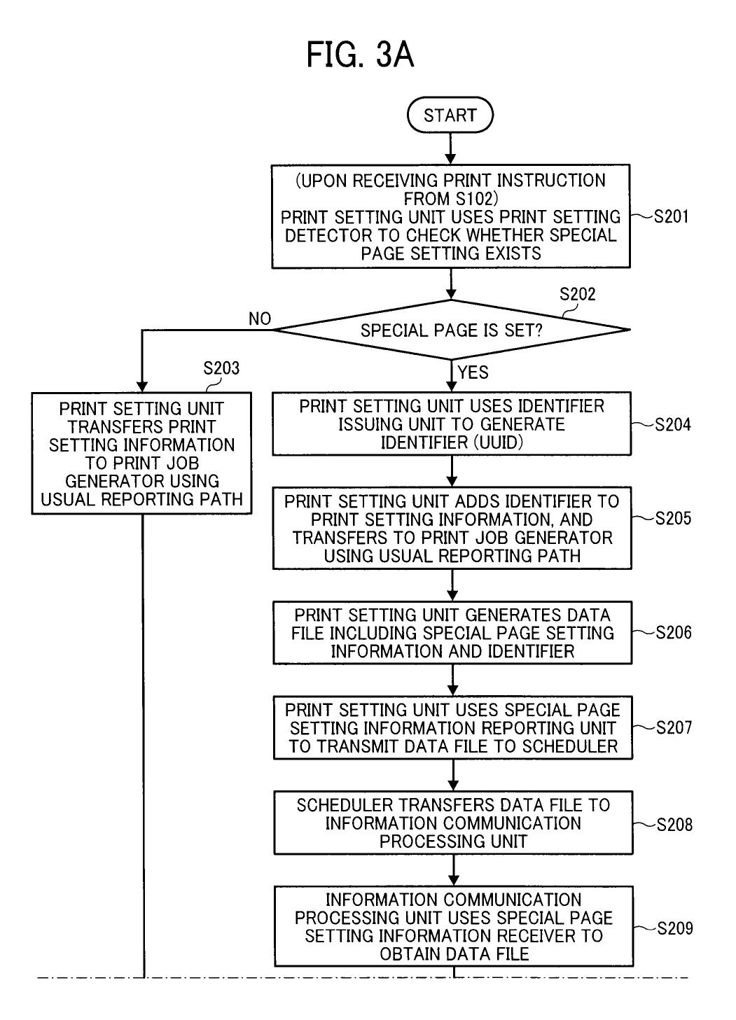

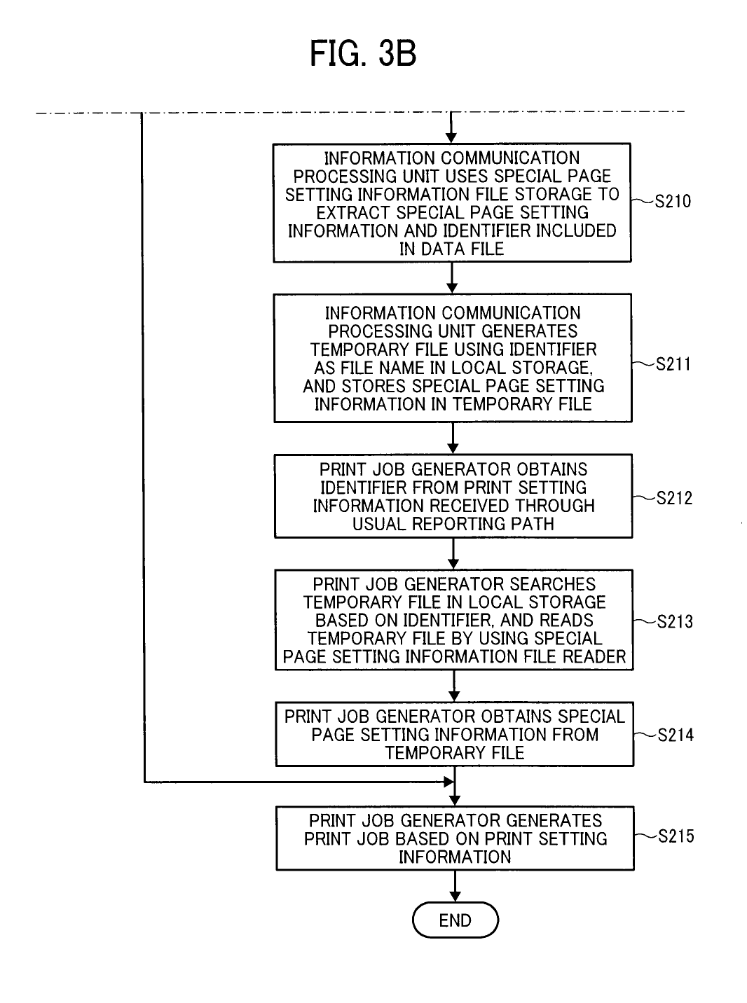

A description is given of print setting process of a printer driver with reference to FIGS. 2 and 3. FIG. 2 is a flow chart showing the steps of print setting process of the printer driver of FIG. 1A, and FIG. 3 is a flow chart showing the steps of a detail process of print setting process of the printer driver of FIG. 1A.

The print setting unit 104 generates a print setting screen as a graphical user interface (GUI). At first, a print setting is input by a user from the generated print setting screen (step S 101 of FIG. 2), and then a print-start button on the print setting screen is pressed (step S102 of FIG. 2), with which an instruction input by the user using the GUI is completed. Then, the process proceeds to the detail process shown in FIG. 3. At step S101, based on the confirmation of print setting input, print setting information of command line input format corresponding to the print setting is generated. Therefore, the print setting unit 104 can function as a print setting information generator.

A description is given of the detail process with reference to FIG. 3. Upon receiving the print instruction (step S102), the print setting unit 104 uses the print setting detector 110 to check whether a special page setting exists or not (step S201) and to determine whether a special page setting exists or not (step S202), in which the print setting detector 110 functions as the print setting detection unit to detect whether special page setting having data size exceeding the maximum data size that the print job generator 106 can receive exists.

If the special page is not set (step S202: NO), the print setting unit 104 transfers the print setting information to the print job generator 106 using a usual reporting path, which is a path including the application 102 and the scheduler 103 (step S203). The usual reporting path is also referred to as a first reporting path. The print job generator 106 generates a print job based on the received print setting information (step S215), and ends the detail process.

If the special page is set (step S202: YES), the print setting unit 104 uses the identifier issuing unit 111 to generate a universally unique identifier (UUID) as an identifier of a temporary file for storing the special page setting information (step S204).

The UUID is an identifier that can identify a device/object uniquely in distributed computing environment, wherein the UUID is defined by a standard of RFC4122.

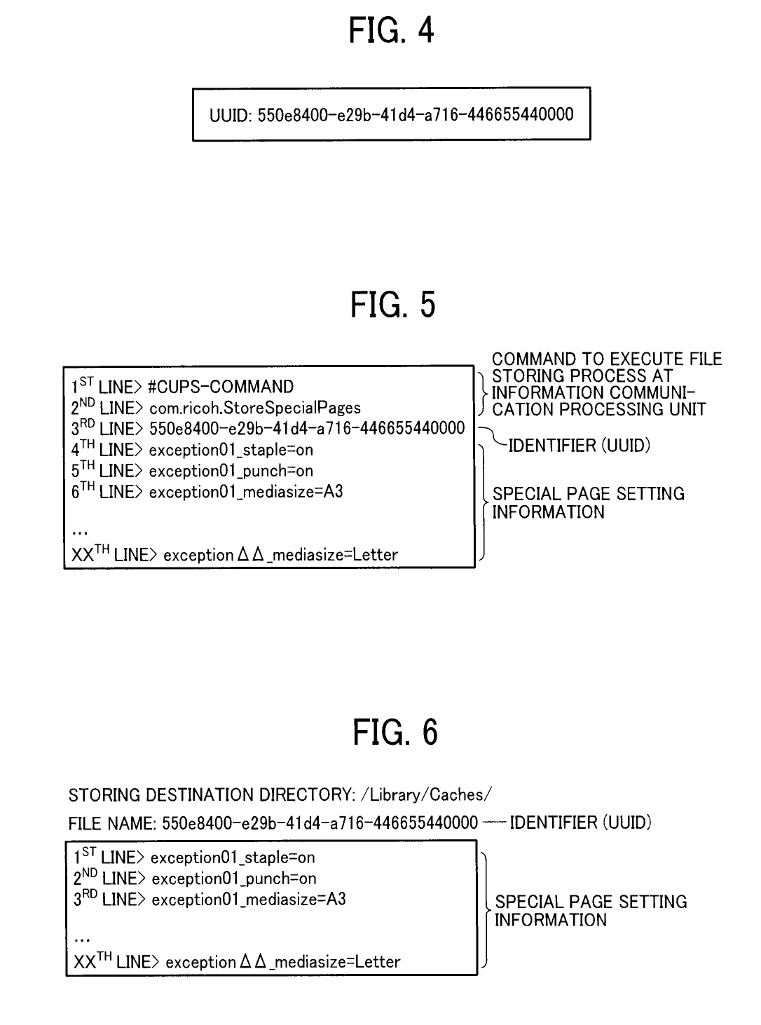

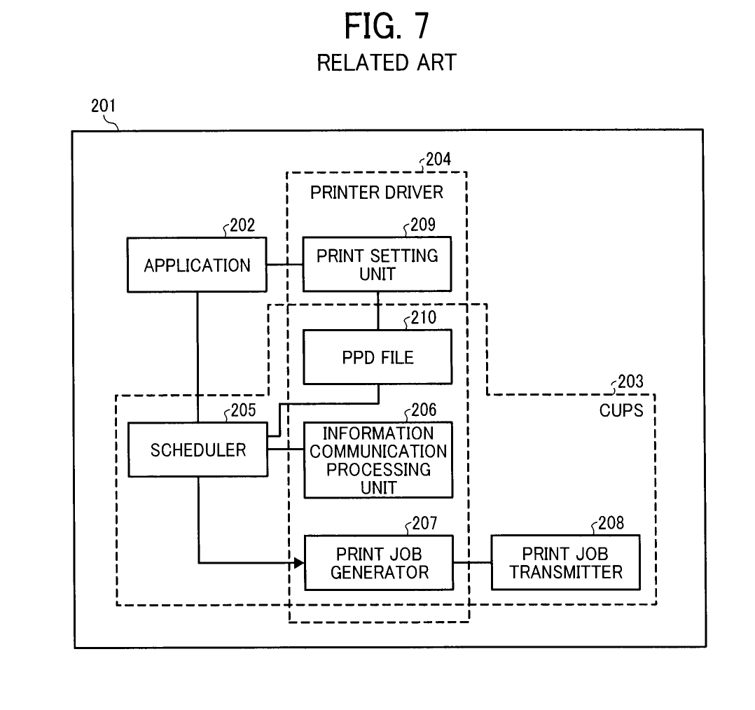

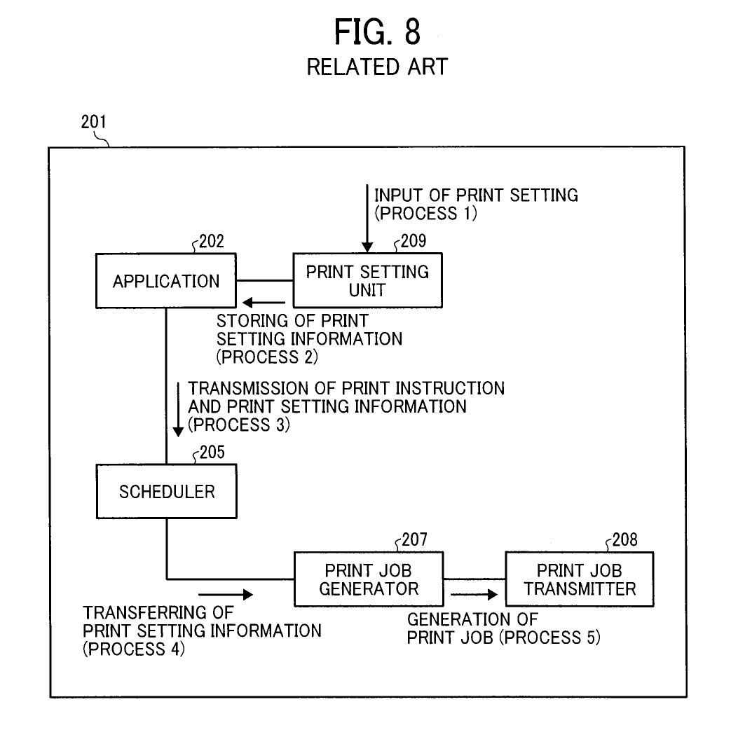

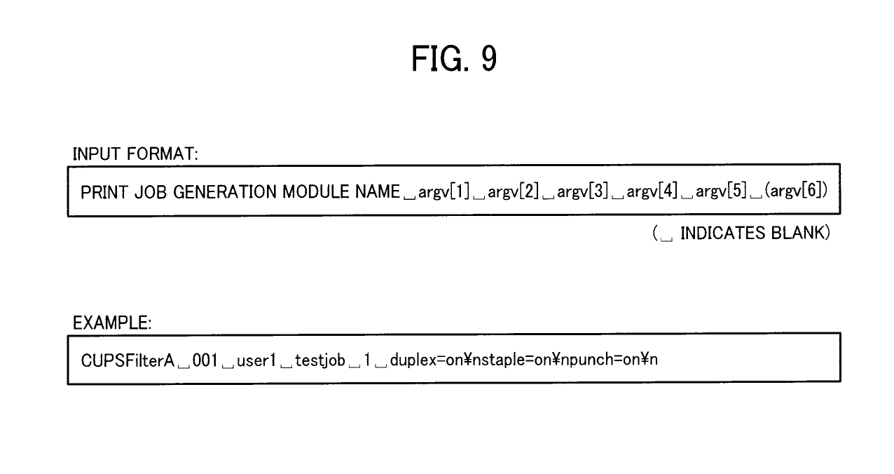

FIG. 4 shows an example of UUID. The UUID is expressed as the number of 32 digits of hexadecimal notation. By using the UUID as a name of a temporary file storing the special page setting, when a special page printing is conducted using a plurality of applications, occurrence of an over-writing to the same one temporary file can be prevented.

In the process shown in FIG. 3, the print setting unit 104 transfers the print setting information with the identifier generated at step S204 to the print job generator 106 through the above mentioned first reporting path (step S205). Therefore, the print setting unit 104 can function as an identification information transmitter.

Then, the print setting unit 104 generates a data file including the special page setting information and the identifier (step S206). Therefore, the print setting unit 104 can function as a data file generator.

FIG. 5 is an example of data file format. As shown in FIG. 5, a CUPS command that is required to transmit the above mentioned data file by the scheduler 103 to the information communication processing unit 105 is written in the first line and the second line. In this example case, a command to execute a file storing process at the information communication processing unit 105 is written. The identifier generated at step S204 is written in the third line. The special page setting information set by the user is written in the fourth line and the subsequent line.

In the process of FIG. 3, the print setting unit 104 uses the special page setting information reporting unit 112 to transmit the data file to the scheduler 103 (step S207). The scheduler 103 transfers the data file to the information communication processing unit 105 (step S208). The information communication processing unit 105 uses the special page setting information receiver 113 to obtain the data file (step S209).

The information communication processing unit 105 uses the special page setting information file storing unit 114 to extract the special page setting information and the identifier included in the data file (step S210). Then, the information communication processing unit 105 uses the special page setting information file storing unit 114 to generate a temporary file using the extracted identifier as a file name in the local storage 109, which is a memory, a storing device or medium such as a hard disk, and stores the special page setting information in the temporary file (step S211). With this configuration, the special page setting information in the data file can be stored by corresponding the special page setting information with the identifier in the data file.

A description is given of a temporary file format with reference to FIG. 6, which is an example of temporary file format. Security requirement is set for UNIX (registered trademark) OS, and a storing destination of a temporary file is set. Therefore, to satisfy the security requirement of UNIX (registered trademark) OS, a storing destination directory is set as “/Library/Cashes/ . . . .” Further, the identifier such as UUID included in the data file generated at step S206 is used as the temporary file name. Further, the special page setting information included in the data file generated at step S206 is stored in the temporary file.

In the process shown in FIG. 3, the print job generator 106 obtains the identifier from the print setting information received through the first reporting path (step S212). Then, the print job generator 106 searches a temporary file in the local storage 109 based on the obtained identifier, and reads the temporary file by using the special page setting information file reader 115 (step S213), and the print job generator 106 obtains the special page setting information from the temporary file (step S214). After obtaining the special page setting information, the temporary file can be deleted, with which remaining of unnecessary temporary file can be preferably prevented.

The print job generator 106 generates a print job based on the obtained special page setting information and the print setting information received through the first reporting path (step S215), and ends the detail process.

The above described information processing apparatus according an example embodiment can devise following features (1) to (5).

(1) By storing special page setting information in a temporary file and reading the temporary file using the print job generator 106, maximum data size limitation such as 256 KB of UNIX (registered trademark) command line input format can be avoided. Further, because the temporary file substantially does not have data storing limit, special page setting information having any data size can be obtained by the print job generator 106, in which data transmission of special page setting information from the print setting unit 104 (i.e., UI module of printer driver) to the print job generator 106 (i.e., print job generation module) can be changed to a second reporting path according to an example embodiment set differently from the above mentioned first reporting path. In the second reporting path, which is described as steps S204 to S214 in FIGS. 3A and 3B, data of special page setting information can be transmitted from the print setting unit 104 to the print job generator 106 via the information communication processing unit 105 and the local storage 109, while the first reporting path (step 203 in FIG. 3A) is from the print setting unit 104 to the print job generator 106 via the application 102 and the scheduler 103. With this configuration, maximum limitation of print setting data that can be processed by the print job generator 106 can be substantially eliminated, and limitation of maximum registration number of special pages for a printer driver using CUPS can be substantially eliminated.

(2) By using the UUID as a name of a temporary file for storing special page setting, when special page printing is conducted using a plurality of applications, occurrence of an over-writing to the same one temporary file can be prevented.

(3) By generating a temporary file in a cache directory (/Library/Caches/) satisfying security requirement of UNIX (registered trademark) OS, printing process can be devised without violating security requirement of UNIX (registered trademark) OS such as MacOSX.

(4) The print setting detector 110 can detect whether a printing condition that exceeds maximum data size (e.g., 256 KB), and has an algorism to determine whether print setting information is to be stored in a temporary file. Therefore, when print setting not exceeding the maximum data size such as 256 KB is set, unnecessary temporary file is not generated.

(5) The print job generator 106 has a function to delete a temporary file after reading the concerned temporary file, with which remaining of unnecessary temporary file in the local storage 109 can be prevented.

In the above described example embodiment of the present invention, the upper limit of register-able special pages for an information processing apparatus having a print architecture based on CUPS can be substantially eliminated, with which convenience can be enhanced.

The present invention can be implemented in any convenient form, for example using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can compromise any suitably programmed apparatuses such as a general purpose computer, personal digital assistant, mobile telephone (such as a Wireless Application Protocol (WAP) or 3G-compliant phone) and so on. Since the present invention can be implemented as software, each and every aspect of the present invention thus encompasses computer software implementable on a programmable device. The computer software can be provided to the programmable device using any storage medium or carrier medium for storing processor-readable code such as a floppy disk, a compact disk read only memory (CD-ROM), a digital versatile disk read only memory (DVD-ROM), DVD recording only/rewritable (DVD-R/RW), electrically erasable and programmable read only memory (EEPROM), erasable programmable read only memory (EPROM), a memory card or stick such as USB memory, a memory chip, a mini disk (MD), a magneto optical disc (MO), magnetic tape, a hard disk in a server, a solid state memory device or the like, but not limited these.

The hardware platform includes any desired kind of hardware resources including, for example, a central processing unit (CPU), a random access memory (RAM), and a hard disk drive (HDD). The CPU may be implemented by any desired kind of any desired number of processors. The RAM may be implemented by any desired kind of volatile or non-volatile memory. The HDD may be implemented by any desired kind of non-volatile memory capable of storing a large amount of data. The hardware resources may additionally include an input device, an output device, or a network device, depending on the type of apparatus. Alternatively, the HDD may be provided outside of the apparatus as long as the HDD is accessible. In this example, the CPU, such as a cache memory of the CPU, and the RAM may function as a physical memory or a primary memory of the apparatus, while the HDD may function as a secondary memory of the apparatus. In the above-described example embodiment, a computer can be used with a computer-readable program, described by object-oriented programming languages such as C++, Java (registered trademark), JavaScript (registered trademark), Perl, Ruby, or legacy programming languages such as machine language, assembler language to control functional units used for the apparatus or system. For example, a particular computer (e.g., personal computer, workstation) may control an information processing apparatus or an image processing apparatus such as image forming apparatus using a computer-readable program, which can execute the above-described processes or steps. In the above-described embodiments, at least one or more of the units of apparatus can be implemented as hardware or as a combination of hardware/software combination. Each of the functions of the described embodiments may be implemented by one or more processing circuits. A processing circuit includes a programmed processor, as a processor includes circuitry. A processing circuit also includes devices such as an application specific integrated circuit (ASIC) and conventional circuit components arranged to perform the recited functions.

Numerous additional modifications and variations are possible in light of the above teachings. It is therefore to be understood that within the scope of the appended claims, the disclosure of the present invention may be practiced otherwise than as specifically described herein. For example, elements and/or features of different examples and illustrative embodiments may be combined each other and/or substituted for each other within the scope of this disclosure and appended claims.

What is claimed is:

1. An information processing apparatus having a print architecture based on Common UNIX (registered trademark) Printing System (CUPS), comprising:
a print setting information generator to generate print setting information indicating print setting based on a print setting input;
a print job generator to generate a print job based on the print setting information;
an identification information issuing unit to generate identification information;
a print setting detector to determine whether a given print setting having a data size exceeding the maximum data size that the print job generator can receive exists in the print setting input;
a data file generator to generate a data file including the identification information generated by the identification information issuing unit and given print setting information indicating the given print setting when the given print setting exists;
a file storing unit to store the given print setting information in the data file in a memory by correlating the given print setting information to the identification information in the data file; and
an identification information transmitter to transmit the identification information to the print job generator,
wherein the print job generator obtains the given print setting information in the memory using the identification information transmitted from the identification information transmitter.

2. The information processing apparatus of claim 1, wherein the file storing unit stores the given print setting information in a cache directory satisfying security requirement of UNIX operating system (OS).

3. The information processing apparatus of claim 1, wherein the identification information issuing unit generates universally unique identifier (UUID) as the identification information.

4. The information processing apparatus of claim 1, wherein when the print job generator obtains the given print setting information, the print job generator deletes the obtained given print setting information from the memory.

5. The information processing apparatus of claim 1, wherein the given print setting includes special page setting.

6. A print processing method conductable by an information processing apparatus having a print architecture based on Common UNIX (registered trademark) Printing System (CUPS), the method comprising the steps of:
generating print setting information indicating print setting based on a print setting input using a print setting information generator;
generating identification information using the identification information issuing unit;
determining whether a given print setting having data size exceeding maximum data size that the print job generator can receive exists in the print setting input using a print setting detector;
generating a data file including the identification information and given print setting information indicating the given print setting using a data file generator when the given print setting exists;
storing the given print setting information in the data file in a memory by correlating the given print setting information to identification information in the data file using a file storing unit;
transmitting the identification information to the print job generator using an identification information transmitter; and
obtaining the given print setting information in the memory using the print job generator based on the transmitted identification information from the identification information transmitter.

7. A non-transitory computer-readable storing medium storing a program that, when executed by a computer, causes the computer to execute a print processing method conductable by an information processing apparatus having a print architecture based on Common UNIX (registered trademark) Printing System (CUPS), the method comprising the steps of:
generating print setting information indicating print setting based on a print setting input using a print setting information generator;
generating identification information using the identification information issuing unit;
determining whether a given print setting having data size exceeding maximum data size that the print job generator can receive exists in the print setting input using a print setting detector;
generating a data file including the identification information and given print setting information indicating the given print setting using a data file generator when the given print setting exists;
storing the given print setting information in the data file in a memory by correlating the given print setting information to identification information in the data file using a file storing unit;
transmitting the identification information to the print job generator using an identification information transmitter; and
obtaining the given print setting information in the memory using the print job generator based on the transmitted identification information from the identification information transmitter.
